(19) United States
(12) Patent Application Publication
(10) Pub. No.: US 2004/0250673 A1
(43) Pub. Date: Dec. 16, 2004

(54) Ergonomic pedal board

(76) Inventor: Paul Michael Salerno, Spokane, WA (US)

Correspondence Address: Paul M. Salerno, 6421 South Dorset Road, Spokane, WA, 99224, US

(21) Appl. No.: 10/459,223

(22) Filed: Jun. 10, 2003

(51) Int. Cl. G10H 3/00; G10H 1/32

(52) U.S. Cl. 84/746

(57) ABSTRACT

An ergonomic pedal board (8) comprising a non-orthogonal shaped body plate (10) with a cooperative loop fabric surface (14) to releasably mount one or more effects pedals (28). Rubber feet (16) are attached to the underside of body plate (10) in three locations that provide tripodal support for stability on uneven or non-level surfaces. Effects pedals (28) are releasably mounted in staggered array with audio jacks (30) unobstructed, facilitating a natural arc of foot movement when actuating pedals by foot. A slotted handle (12) is incorporated into body plate (10) that attaches to the vertical tube (22) of a microphone stand (25). The forward end of body plate (10) is supported by the microphone stand's base (24). This support elevates the forward end of pedal board (8) and weights base (24) of microphone stand (25). A receptacle (20) is provided in the forward end of body plate (10) that accepts a gooseneck lamp (32) for illumination of pedal board (8) and effects pedals (28) in conditions of low ambient light. The gooseneck lamp's (32) DC power jack (34) accepts a source of DC power common to effects pedals (28) that are mounted proximate to gooseneck lamp (32).

### FIELD OF INVENTION

This invention relates to new and useful improvements in releasable mounting pedal boards for foot operated sound effects pedals. More specifically, this invention pertains to the shape of pedal boards and to the mounting arrangement of effects pedals on such pedal boards. This invention also pertains to the attachment of pedal boards to microphone stands, and to the illumination of pedal boards and of the effects pedals mounted thereon.

### BACKGROUND

Foot operated sound effects generators, commonly known as “effects pedals”, or “pedals”, are frequently used by guitarists and other musicians to modulate or alter the sound of a musical instrument. During performance, these pedals are placed at the feet of the musician for ready foot actuation and are connected by audio cables and power supply cables. A pedal board serves as a platform for numerous effects pedals, which are mounted to the pedal board by a releasable means. One common method of mounting pedals is through the use of a cooperative hook-and-loop fastening system marketed under the trade name “VELCRO™”.

Mounting effects pedals to a pedal board serves several purposes. A pedal board organizes numerous pedals in positions that are familiar to the musician, reduces the possibility of accidental disconnection of audio and/or power supply cables, and reduces the time required to connect, set up and tear down the equipment for performance.

Pedal boards seen in prior art are rectangular, box like or orthogonal in shape, and are designed to hold effects pedals adjacent to one another, side by side, in one or more rows. These orthogonal shapes have several disadvantages. The orthogonal shape is inherently unstable on any surface that is not level, due to its four-cornered or flat resting surface. Further, an orthogonal shape makes inefficient use of floor space when shared with a microphone stand during performance.

Most effects pedals in use today contain their audio input and output jacks on their sides. Orthogonal pedal boards are designed to mount these pedals in a linear row, side by side, whereby the interconnecting audio cable ends interfere with each other and require that the pedals be placed some distance apart from each other, particularly when it is necessary to connect or disconnect audio cables. This side by side mounting thus makes inefficient use of space on the surface of the pedal board.

During performance, effects pedals are mounted on a pedal board that is placed on the floor in front of the musician. From this position, the musician actuates his or her various pedals by foot. Orthogonal pedal boards designed to mount effects pedals in a side by side layout require the musician's foot to move sideways in a linear motion when moving from pedal to pedal. This unnatural, side to side linear movement of the musician's foot is inefficient and causes fatigue. A more natural arc of foot movement is desirable when actuating effects pedals.

Pedal boards seen in prior art are not illuminated, and no means are provided to illuminate the effects pedals mounted on the upper surface of such pedal boards. Performance stages are often dimly lit and many pedals have controls that require adjustment by hand, in addition to foot-actuated switches. A source of illumination is desirable to aid the musician in adjusting these controls in conditions of poor ambient light.

The applicant has invented the ergonomic pedal board, intended to resolve the deficiencies described above and as seen in the prior art.

### OBJECTS AND ADVANTAGES

An object of the ergonomic pedal board is to provide a pedal board that is stable when used on an uneven surface. This is accomplished by supporting the pedal board on three points, rather than on four points or on a flat-bottomed surface as seen in the prior art.

It is another object of the ergonomic pedal board to provide a pedal board that utilizes floor space efficiently by attachment to microphone stands that are commonly used in conjunction with pedal boards during performance.

A further object of the ergonomic pedal board is to provide a pedal board that permits effects pedals to be mounted in close proximity to each other by staggering the position of pedals on the upper surface of the pedal board. A staggered array leaves side-mounted audio jacks unobstructed, permitting pedals to be mounted in closer proximity, and permitting audio cables to be connected and/or disconnected without removing pedals from the pedal board. Staggered mounting also enables the musician's foot to move in a natural ergonomic arc when moving from pedal to pedal, thereby facilitating control and reducing fatigue.

A further additional object of the ergonomic pedal board is to provide a pedal board that illuminates the upper surface of the board and the pedals mounted thereon.

With the above and other objects in view, my invention resides in the novel features of form, design, arrangement and function presently described and pointed out in the claims.

### SUMMARY OF THE ERGONOMIC PEDAL BOARD

The ergonomic pedal board provides an optimum solution to the deficiencies of prior art previously described. The ergonomic pedal board is a flat surface upon which effects pedals are releasably mounted. It is non-orthogonal in shape and is supported at three points. One point of support is at the forward end. The other two points of support are at either side of the wider rear end, closest to the musician. These three points of support result in stability on both non-level and uneven surfaces.

The ergonomic pedal board's unique shape allows mounting of effects pedals in a staggered array that permits pedals to be placed in close proximity to one another, thereby utilizing space on the board's surface more efficiently. A staggered array also results in unobstructed access to the audio input and output jacks on the sides of the pedals. Audio cables may be connected or disconnected without removing pedals from the pedal board. A further novel feature of staggered pedal mounting is the natural arc of foot movement that results when the musician's foot moves from one pedal to another during performance.

A preferred embodiment of the ergonomic pedal board incorporates a method of attaching the forward end of the pedal board to the vertical support tube of a microphone stand, just above the base of the stand. When so attached, the forward end of the pedal board is elevated while maintaining its three points of support. This attachment of pedal board to microphone stand results in several additional novel features and benefits:

a) it tilts the pedal board to an angle that improves the musician's view of effects pedals and further facilitates foot access;

b) it permits audio and power cables to be routed under the pedal board and exit from either side (stage right or stage left) of the pedal board;

c) it greatly reduces the amount of stage space required when a pedal board and microphone stand are used simultaneously;

d) it allows the musician to reposition the pedal board/microphone stand assembly on stage without bending over, by lifting the entire assembly up by the microphone stand's vertical support tube;

e) it further stabilizes the microphone stand by distributing support over a wider area, and by adding weight to the stand at its base.

Another preferred embodiment of the ergonomic pedal board incorporates a source of illumination such as a gooseneck lamp, which illuminates the upper surface of the pedal board and the effects pedals mounted thereon.

### DRAWINGS

Drawing Figures

In the drawings, related figures have the same number but different alphabetic suffixes.

FIG. 1 is a perspective view of the ergonomic pedal board viewed from the side.

FIG. 2 is a perspective view from the forward end.

FIG. 3 is a top plan view of the upper surface from the musician's perspective.

FIGS. 4(a) and 4(b) are bottom plan views of the lower surface showing three points of support, and three areas of support, respectively.

FIG. 5(a) is a perspective view of the ergonomic pedal board attached to a round base microphone stand.

FIG. 5(b) is a perspective view of the ergonomic pedal board attached to a tripod base microphone stand.

FIG. 6 is a perspective view showing unobstructed access to effect pedals' audio jacks when pedals are in staggered array. FIG. 6 also shows the insertion of a gooseneck lamp for illumination of effects pedals.

FIG. 7 is a perspective view of a gooseneck lamp assembly.

### REFERENCE NUMERALS IN DRAWINGS

| | |
|---|---|
| 8 | pedal board |
| 10 | body plate |
| 11 | rounded cutout |
| 12 | slotted handle |
| 14 | cooperative loop fabric surface |
| 16 | rubber foot |
| 18 | decorative trim |
| 20 | gooseneck lamp receptacle |
| 22 | vertical support tube |
| 24 | base, round microphone stand |
| 25 | microphone stand |
| 26 | base, tripod microphone stand |
| 28 | effects pedal |
| 30 | audio jack |
| 32 | gooseneck lamp |
| 34 | DC power jack |
| 36 | hooded bulb |
| 38 | gooseneck base |
| 40 | flexible tube |

### DETAILED DESCRIPTION OF PREFERRED EMBODIMENTS

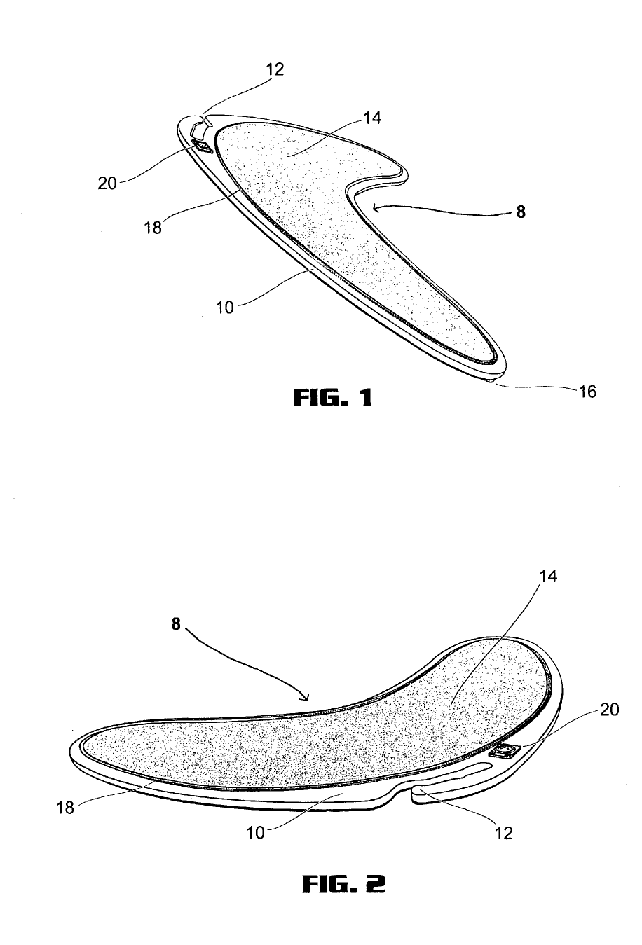

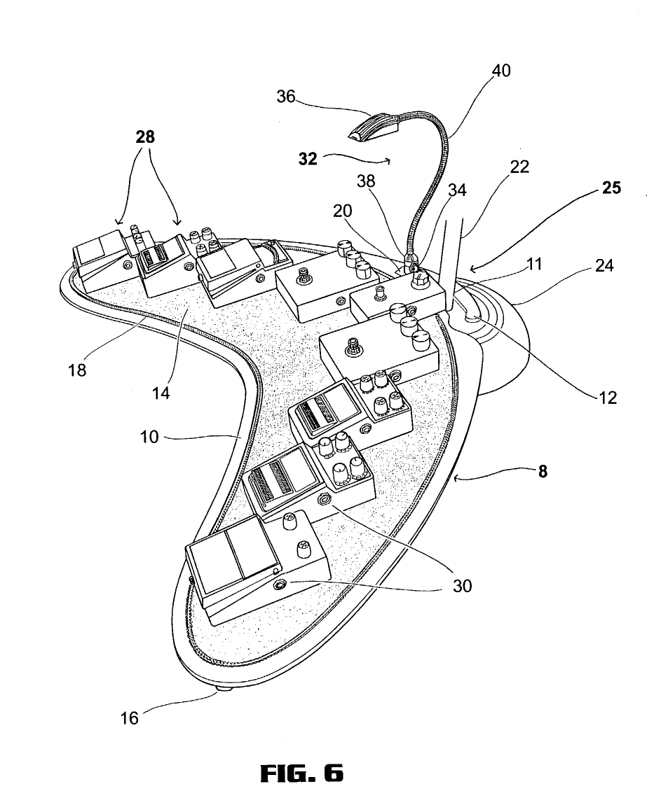

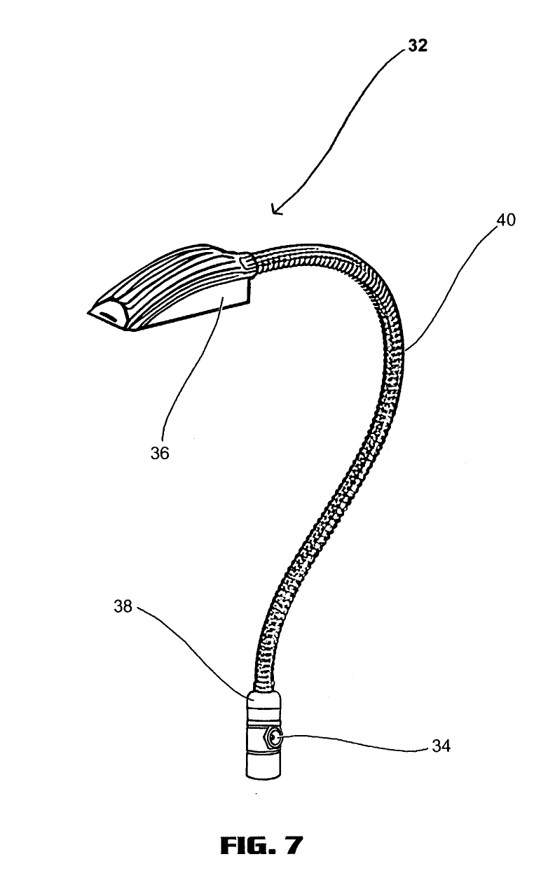

FIGS. 1 and 2 show perspective views of an ergonomic pedal board 8. Components include a body plate 10, a cooperative loop fabric surface 14, a decorative trim 18 that surrounds loop fabric surface 14, and a slotted handle 12 that is machined into body plate 10. A rubber foot 16 is attached to an underside of body plate 10 at three points proximate to the perimeter of body plate 10, producing tripodal support. A gooseneck lamp receptacle 20 is mounted on a forward upper surface of body plate 10 to accept a gooseneck lamp 32 as shown in FIGS. 6 and 7.

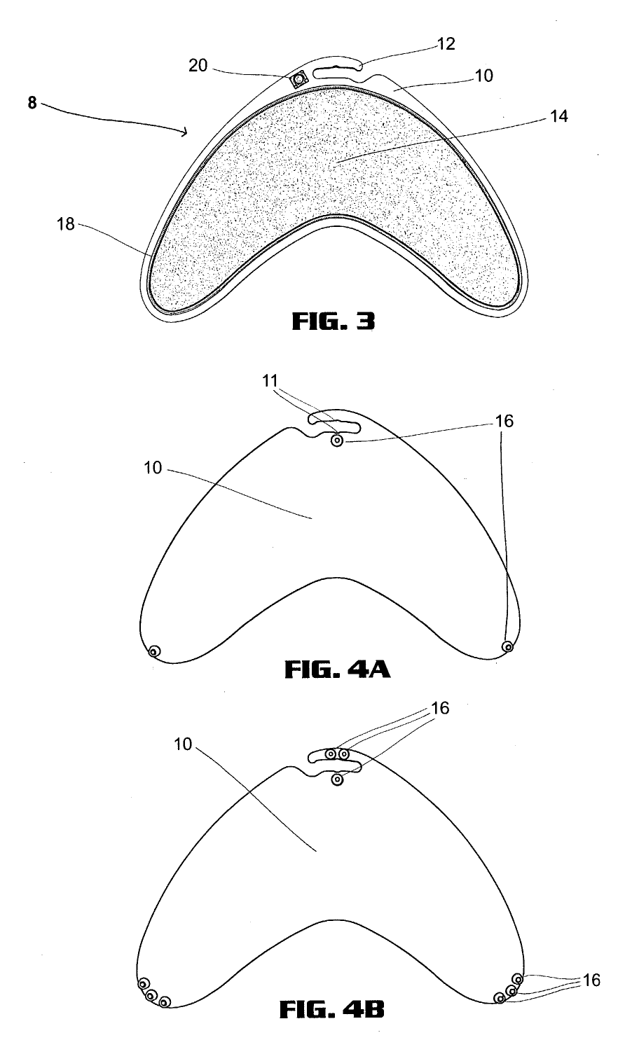

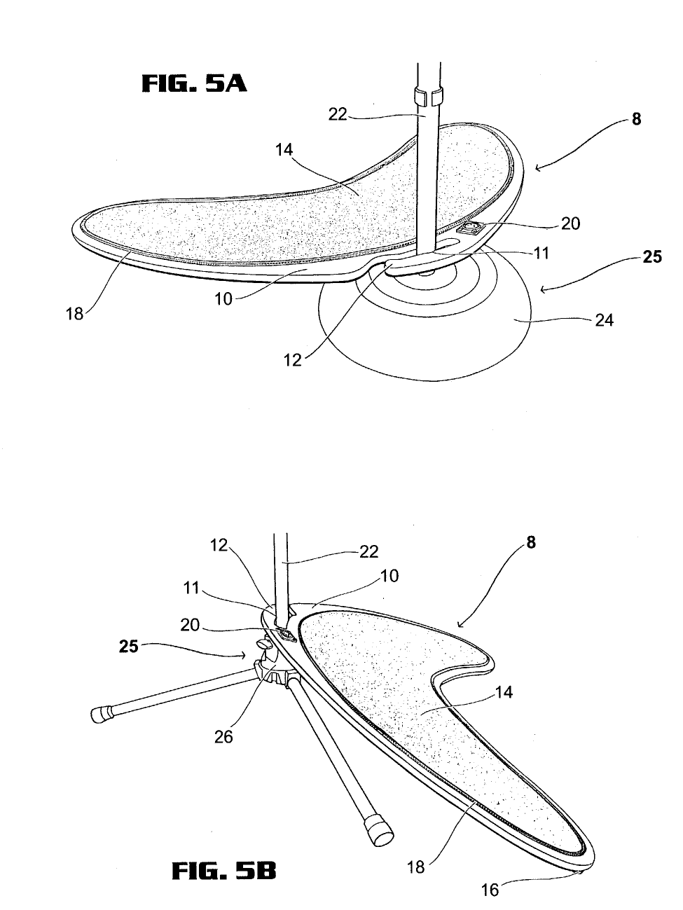

FIG. 3 shows a plan view of ergonomic pedal board 8 when viewed from a musician's perspective. Body plate 10 is machined from solid High Density Polyethylene (HDPE). A channel is routed into the upper surface of body plate 10 to accept decorative trim 18. Trim 18 comprises a flexible steel tubing that is pressed into body plate 10. Loop fabric surface 14 is bonded to the upper surface of body plate 10 with its edges secured by trim 18. Loop fabric surface 14 is one part of a two-part hook-and-loop cooperative fastening system such as commonly marketed under the trade name “VELCRO™”. A second part of this cooperative fastening system is a provided adhesive-backed hook strip that is adhered to an underside of effects pedals 28 as shown in FIG. 6, permitting pedals 28 to be releasably mounted on loop fabric surface 14. Slotted handle 12 is wide enough to slide laterally onto a vertical support tube 22 of a microphone stand 25 as shown in FIGS. 5A and 5B. A hole is machined into a forward upper surface of body plate 10 to accept lamp receptacle 20.

FIG. 4A is a plan view of the underside of ergonomic pedal board 8. This figure shows a rounded cutout 11 that is machined into slotted handle 12 to lock in place vertical support tube 22 as shown in FIGS. 5A and 5B.

FIGS. 4A and 4B are both bottom plan views of an underside of ergonomic pedal board 8 showing tripodal support. FIG. 4A shows three rubber feet 16 that produce three points of support. FIG. 4B shows three clusters of feet 16 that produce three areas of tripodal support.

FIG. 5A is a perspective view of ergonomic pedal board 8 attached to microphone stand 25 with a round base 24. In this preferred embodiment, base 24 acts as a forward area of tripodal support necessary for stability on uneven or non-level surfaces.

FIG. 5B is a perspective view of ergonomic pedal board 8 attached to microphone stand 25 having a tripod base 26.

FIG. 6 is a perspective view of ergonomic pedal board 8 showing effects pedals 28 in staggered array. Audio jacks 30 are unobstructed for insertion of audio cables (not shown). Effects pedals 28 are mounted in close proximity to each other. Gooseneck lamp 32 is inserted into receptacle 20 to illuminate effects pedals 28 during conditions of low ambient light. Gooseneck lamp 32 is powered by a DC power source (not shown) common to pedals 28.

FIG. 7 is a perspective view of gooseneck lamp 32, incorporating a DC power jack 34 common to that used by many effects pedals 28. Power jack 34 is mounted in the side of a gooseneck base 38. A flexible tube 40 houses wiring and provides support for a hooded bulb 36. Utilizing side-mounted power jack 34, gooseneck lamp 32 receives power from a power source (not shown) common to pedals 28 that are mounted proximate to gooseneck lamp 32.

Advantages

From the description above, numerous advantages of the ergonomic pedal board become evident:

The ergonomic pedal board's shape produces tripodal support that results in stability on uneven or non-level surfaces. The shape also permits effects pedals to be mounted in staggered array and in close proximity to each other, efficiently utilizing space on the surface of the pedal board. A staggered array also results in unobstructed access to side-mounted audio jacks, permitting connection and disconnection of audio cables without removing pedals from the pedal board. Further, staggering of pedals allows a natural arc of foot movement when moving from one pedal to the next during performance.

Attachment to a microphone stand elevates the forward end of the ergonomic pedal board and improves visibility of effects pedals while enhancing foot control. Audio and power cables may be routed under the pedal board. Covered and protected by the body plate, cables become less of a safety hazard and are less susceptible to accidental disconnection during performance. Microphone stand attachment also makes efficient use of valuable stage space. Attachment of the ergonomic pedal board to a microphone stand's vertical support tube weights the base of the stand and increases the stability of both microphone stand and pedal board. The pedal board becomes ideally situated for foot operation of effects pedals while utilizing a microphone for singing. Tripodal support of the pedal board is maintained as the microphone stand's base serves as the pedal board's forward support point.

The gooseneck lamp's side-mounted DC power jack accepts the same power source as the effects pedals mounted proximate to the gooseneck lamp, making illumination of the pedal board fast and easy. In conditions of low ambient light, the gooseneck lamp illuminates the entire upper surface of the pedal board for adjustment of the effects pedals' various settings and controls.

Operation—FIG. 6

Effects pedals 28 are releasably mounted in staggered array on loop fabric surface 14 of ergonomic pedal board 8, so that audio jacks 30 remain unobstructed. Audio and power cables (not shown) are connected. The entire assembly is then transported and operated in this configuration. For performance, pedal board 8 with mounted pedals 28 is placed on the floor in front of the musician.

Pedal board 8 may be attached to microphone stand 25 by holding pedal board 8 in a horizontal position and sliding slotted handle 12 laterally over vertical support tube 22, just above base 24 of stand 25. With the forward end of pedal board 8 supported by base 24, the aft end of pedal board 8 is allowed to tilt down and rest on the floor. This tilting action effectively narrows the width of rounded cutout 11, pinching vertical support tube 22, pre-loading handle 12 and locking pedal board 8 to microphone stand 25. Power, audio and microphone cables (not shown) may then be routed under pedal board 8, and are covered by body plate 10 for exit stage left or stage right. Tripodal support of body plate 10 is maintained as base 24 serves as pedal board's 8 forward support point.

In conditions of low ambient light, gooseneck lamp 32 is inserted into receptacle 20 and connected via DC power jack 34 to a source of power (not shown) common to that which powers effects pedals 28. The entire upper surface of pedal board 8 is thus illuminated for adjusting various settings and controls of pedals 28.

### Conclusion, Ramifications, and Scope of Invention

Accordingly, the reader will see that the ergonomic pedal board of this invention provides many improvements in function and efficiency over the prior art.

The ergonomic pedal board is stable on uneven surfaces as well as surfaces that are not level, since it is supported by three points or areas of support.

Staggering the array of effects pedals utilizes surface space efficiently and results in unobstructed access to the pedals' audio jacks, as well as offering a more natural arc of foot movement when moving from one pedal to the next during performance.

Valuable stage space is utilized more efficiently when the ergonomic pedal board is attached to a microphone stand. The frontal elevation and angled surface that results from attachment directly above the microphone stand's base improves the musician's view of pedals and facilitates foot control. This frontal elevation also creates an area under the pedal board for audio and power cables to be routed. Another benefit of microphone stand attachment is the resulting increased stability of the stand, making it less prone to tipping over. Stability of the pedal board itself is also improved as the pedal board's slotted handle locks to the vertical support tube and becomes less susceptible to movement when pedals are actuated by foot. Tripodal support of the pedal board is maintained, as the base of the microphone stand acts as one of the pedal board's three points of support.

Illuminating the ergonomic pedal board's top surface and effects pedals aids the musician when adjusting pedal controls in conditions of low ambient light. The addition of a gooseneck lamp that shares a common DC power source with effects pedals makes illumination easy and convenient.

Although the prior description contains many specificities, these should not be construed as limiting the scope of the invention but rather as providing illustrations of some preferred embodiments. For example, the pedal board can have other shapes that are conducive to a staggered array of pedals, such as triangular, quarter-moon, or swept-wing. It may be larger or smaller in size, and may be made of any material of suitable strength. Some examples of suitable materials are wood, metal, fiberglass, molded plastic or plexiglass.

The top surface of the pedal board may not be covered with a loop fabric, and the means of releasably mounting effects pedals may be a cooperative hook-and-loop system other than the one described herein. For example, the cooperative interlocking system such as that commonly marketed by 3M Company under the trade name “Dual-Lock” may be used.

Decorative trim may be made of plastic, rubber, or other suitable materials. It may be made of insulated wire. A power distribution system to provide power to effects pedals and/or for illumination of the pedal board may be incorporated into the trim. The pedal board may not have decorative trim at all.

The method of microphone stand attachment may be a clamp, pin or other holding device. Support points may be clusters of rubber feet, pads or elevated areas on the bottom surface of the pedal board. The body plate itself could be utilized as one or more support points.

The source of illumination may be a lamp or series of lamps. A lamp or lamps may be attached to the microphone stand, rather than mounted on the pedal board itself. Perimeter lighting may be incorporated into, or in place of, the decorative trim. The source of illumination may be powered from alternate sources.

Thus the scope of the ergonomic pedal board should be determined not by the embodiments illustrated, but by the appended claims and their legal equivalents.

Having thus described the ergonomic pedal board, what is claimed and desired to be protected by Letters of Patent is:

1. A pedal board for mounting one or more effects pedals used in conjunction with a musical instrument, said pedal board comprising:
a) a body plate having a relatively flat upper surface;
b) a shape that is narrow at a forward end and substantially wider at an aft end;
c) means on an upper surface of said plate for releasably mounting effects pedals;
d) means of supporting said body plate's lower surface at three points proximate to the perimeter of said body plate.
whereby said pedal board is stabilized when resting on an uneven or non-level surface.

2. The pedal board of claim 1 further characterized in that the means of releasably mounting effects pedals consists of a cooperative hook-and-loop fastening system whereby one of the cooperative elements is adhered to said pedal board's upper surface and the other cooperative element is adhered to the bottom surface of each of the mounted effects pedals.

3. The pedal board of claim 1 further characterized in that the means of support for said pedal board's lower surface comprises three smaller surfaces or areas, such as rubber feet, that result in a tripodal base;
whereby said pedal board is stabilized when resting on an uneven or non-level surface.

4. A pedal board for mounting one or more effects pedals used in conjunction with a musical instrument, said pedal board comprising:
a) a body plate having a relatively flat upper surface;
b) means for attaching said plate to a base or vertical support tube of a microphone stand.

5. The pedal board of claim 4 further characterized in that the means of attaching the body plate to the microphone stand comprises a slotted handle on the forward end of said body plate;
whereby the forward end of said body plate rests on said microphone stand's base and is supported by said base, thereby elevating the forward end of said body plate to a more ergonomic position and stabilizing said microphone stand.

6. A method for attaching a pedal board to a microphone stand, comprising the steps of:
a) providing a slotted handle in a forward end of said pedal board, and
b) passing the opening of said slotted handle laterally over the vertical support tube of said microphone stand, and
c) lowering the aft end of said pedal board until it is supported by the same surface that supports said microphone stand,
whereby the forward end of said pedal board rests on said microphone stand's base and is supported by said base, thereby elevating the forward end of said pedal board and further stabilizing said microphone stand by adding the weight of said pedal board to said base.

7. A pedal board for mounting one or more effects pedals used in conjunction with a musical instrument, said pedal board comprising:
a) a body plate having a relatively flat upper surface;
b) means for illuminating said upper surface and said effects pedals attached thereto;
whereby the adjustment controls of said effects pedals are illuminated and may be adjusted by visual reference in conditions of low ambient light.

8. The pedal board of claim 7 further characterized in that the means for illuminating the upper surface comprises a gooseneck lamp.

9. The pedal board of claim 7 further characterized in that the source of power for illumination comprises a power source that is common to one or more said effects pedals mounted on said pedal board.

10. A gooseneck lamp to provide illumination of a pedal board, said gooseneck lamp comprising:
a) A bulb and wiring to provide power to said bulb;
b) a mounting base and a flexible tube to house wiring and provide support for said bulb;
c) a DC power input jack mounted in said base and wired to said bulb;
whereby said gooseneck lamp may be inserted into a receptacle on said pedal board and illuminated by a source of power common to that which powers said pedal board's mounted effects pedals.
